(19) United States
(12) Patent Application Publication
(10) Pub. No.: US 2015/0276145 A1
(43) Pub. Date: Oct. 1, 2015

(54) BATWING LIGHT BEAM DISTRIBUTION USING DIRECTIONAL OPTICS

(71) Applicants: Zhuo Wang, Middleton, MA (US); John Luciani, Wakefield, MA (US); Bruce Radl, Stow, MA (US)

(72) Inventors: Zhuo Wang, Middleton, MA (US); John Luciani, Wakefield, MA (US); Bruce Radl, Stow, MA (US)

(73) Assignee: OSRAM SYLVANIA Inc., Danvers, MA (US)

(21) Appl. No.: 14/242,238

(22) Filed: Apr. 1, 2014

(51) Int. Cl. F21K 99/00; F21V 7/00

(52) U.S. Cl. CPC F21K 9/50; F21V 7/0066; F21Y 2101/02

(57) ABSTRACT

A luminaire is provided to redirect incidence light from one or more solid state light sources to a batwing distribution with both tunable peak angle and beam width. The peak angle is able to be tuned from 90 degree to 0 degree from the incidence direction with very high efficiency. The beam width is able to be tuned with either narrow beam angle solid state light sources for high efficiency or TIR lens or the optical properties of a reflector for versatility. Uniform illuminance distribution is thus achieved across a wide field with or without a prism or diffuser cover.

### TECHNICAL FIELD

The present invention relates to lighting, and more specifically, to luminaires with directional optics.

### BACKGROUND

For certain lighting applications, it may be desirable to provide a luminaire that produces a light distribution that reduces the glare experienced by an observer. Glare may be produced by brightness (luminance) in the visual field of the observer that is sufficiently greater than the luminance to which the eyes of the observer are adapted, thus resulting in annoyance, discomfort and possibly impaired visual performance to the observer.

Glare may be categorized as direct glare or reflected glare. Direct glare may be understood as glare arising from luminance projected from a light source directly into the visual field of the observer, whereas reflected (specular) glare may be understood as glare arising from luminance from a light source which is reflected into the visual field of the observer.

As disclosed by U.S. Pat. No. 3,721,818, a batwing light distribution may be understood as a light distribution that reduces luminance at large angles from the nadir (i.e. near the horizontal) to reduce direct glare, as well as reduces luminance at small angles from the nadir (i.e. near the vertical) to reduce reflected glare.

### SUMMARY

Solid state light sources, such as but not limited to light emitting diodes, have been used with a specifically constructed bubble lens to provide a batwing light distribution. With such light sources, it may be possible to achieve a particular batwing light distribution by changing the lens design. However, modification of the batwing light distribution by changing the lens presents several challenges. First, with regards to cost, a batwing lens may add as much as twenty percent to the total cost of a light source as compared to a more conventional lens. If a large number of solid state light sources are required, e.g. for outdoor luminaires where forty or more solid state light sources may be required, the additional lens cost will have a significant impact. As to design, depending on how tightly the solid state light sources are packed, there may be interference between the lenses, and the lenses may restrict electrical options. For instance, the light emitted from one solid state light source lens will interfere with the neighboring solid state light source lenses and thus change its direction, which will further affect both the light efficiency and the final distribution. It may be possible to minimize the interference by placing the solid state light sources as sparsely as possible, but this will expand the size and cost of the substrates the solid state light sources are on, such as but not limited to metal core printed circuit boards (MCPCBs), as well as the luminaire.

In addition to potential interference between the lenses, a batwing lens usually introduces around 10% or more of optical loss. Furthermore, since another prism or diffusive cover is usually used for glare control, ingress protection and/or aesthetics, the total optical loss will be 20% or more, which is quite significant. Batwing lenses also may not provide reliable attachment in an environment that runs hot and cold, i.e., in which the temperature cycles every day. As such, the lens components may decrease the system reliability. Off-the-shelf selection for batwing lenses is also very limited in general, which further complicates the design process given it is not generally possible to change the light distribution of batwing lens without a re-design of the lens and creation of a new lens. Furthermore, since the lenses are injection molded, the design to production process may consume a significant amount of time and expense, which may be further compounded by having to overcome interference between the lenses and optical losses with numerous iterations of prototypes.

Finally, certain applications may require both downwardly and upwardly directed light. One example is the recently re-lamped National Mall, where an additional solid state light source board is placed on top of the light engine to provide uplight. For other applications such as parking garage luminaires, it is also desirable to have a certain amount of light to illuminate the ceiling, which is not possible with a batwing lens design since the substrates are facing down.

Embodiments provide a luminaire with solid state light sources, where the luminaire has a batwing light distribution that improves upon the art and overcomes the foregoing challenges.

In an embodiment, there is provided a luminaire. The luminaire includes: a light-emitting arrangement comprising a hub having at least one light-emitting side; and at least one light engine located on the at least one light-emitting side of the light-emitting hub, the at least one light engine comprising at least one solid state light source coupled to a substrate, the substrate arranged such that light from the at least one solid state light source is emitted at a light angle in a range of 0 degrees to 90 degrees from nadir to create a batwing distribution.

In a related embodiment, the hub of the light-emitting arrangement may include a plurality of sides that form a truncated pyramid, and the at least one light-emitting side of the hub may be provided by one of the plurality of sides of the truncated pyramid. In a further related embodiment, the hub may have a shape of a truncated cone.

In another related embodiment, the substrate may be arranged such that direct light from the at least one solid state light source is emitted from the light-emitting arrangement at a direct light angle in a range of 0 degrees to 90 degrees from nadir. In a further related embodiment, the substrate may be arranged at a board angle in a range of 90 degrees to 180 degrees from nadir.

In yet another related embodiment, the light-emitting arrangement may further include a reflector, and the substrate may be arranged such that direct light from the at least one solid state light source may be reflected by the reflector and the reflected light may be emitted from the light-emitting arrangement at a reflected light angle in a range of 0 degrees to 90 degrees from nadir. In a further related embodiment, the substrate may be arranged at a board angle in a range of 0 degrees to 90 degrees from nadir. In a further related embodiment, the substrate may be arranged such that direct light from the at least one solid state light source may be emitted from the light-emitting arrangement at a direct light angle in a range of 90 degrees to 180 degrees from nadir.

In still another related embodiment, the at least one solid state light source may have a planar light-emitting surface and may include a total internal reflection lens that collimates light from the at least one solid state light source such that light emitted from the planar surface may be emitted substantially perpendicular to the planar surface. In yet still another related embodiment, the at least one solid state light source may have a full width at half maximum of less than 80 degrees. In still yet another related embodiment, the at least one solid state light source may have a full width at half maximum in a range of 80 to 150 degrees.

In yet still another related embodiment, the substrate may be further arranged such that upwardly directed direct light from the at least one solid state light source may be emitted from the light-emitting arrangement. In still yet another related embodiment, the at least one light engine may include a plurality of solid state light sources coupled to the substrate and arranged in a geometric pattern. In yet another related embodiment, the light-emitting arrangement may further include an enclosure that overlies the hub.

### BRIEF DESCRIPTION OF THE DRAWINGS

The foregoing and other objects, features and advantages disclosed herein will be apparent from the following description of particular embodiments disclosed herein, as illustrated in the accompanying drawings in which like reference characters refer to the same parts throughout the different views. The drawings are not necessarily to scale, emphasis instead being placed upon illustrating the principles disclosed herein.

FIG. 1 shows a bottom perspective view of a luminaire according to embodiments disclosed herein.

FIG. 2 is a side view of the luminaire of FIG. 1 according to embodiments disclosed herein.

FIG. 3 is a side view of a luminaire according to embodiments disclosed herein.

FIG. 4 is a side view of a luminaire according to embodiments disclosed herein.

FIGS. 5-8 are top views of light-emitting hubs of luminaires having different asymmetric arrangements of one or more solid state light sources located thereon, according to embodiments disclosed herein.

FIG. 9 is a side view of a luminaire having a conical light-emitting hub, according to embodiments disclosed herein.

FIG. 10 is a top view of the conical light-emitting hub of FIG. 9 showing symmetrically distributed solid state light sources to provide 360 degrees of lighting coverage, according to embodiments disclosed herein.

FIG. 11 is a top view of a conical light-emitting hub of a luminaire having different asymmetric arrangements of one or more solid state light sources thereon, according to embodiments disclosed herein.

FIG. 12 is a side view of a luminaire having a cylindrical light-emitting hub according to embodiments disclosed herein.

FIG. 13 is a top view of the cylindrical light-emitting hub of FIG. 12 showing symmetrically distributed solid state light sources to provide 360 degrees of lighting coverage, according to embodiments disclosed herein.

FIG. 14 is a top view of a cylindrical light-emitting hub of a luminaire having different asymmetric arrangements of the solid state light sources, according to embodiments disclosed herein.

### DETAILED DESCRIPTION

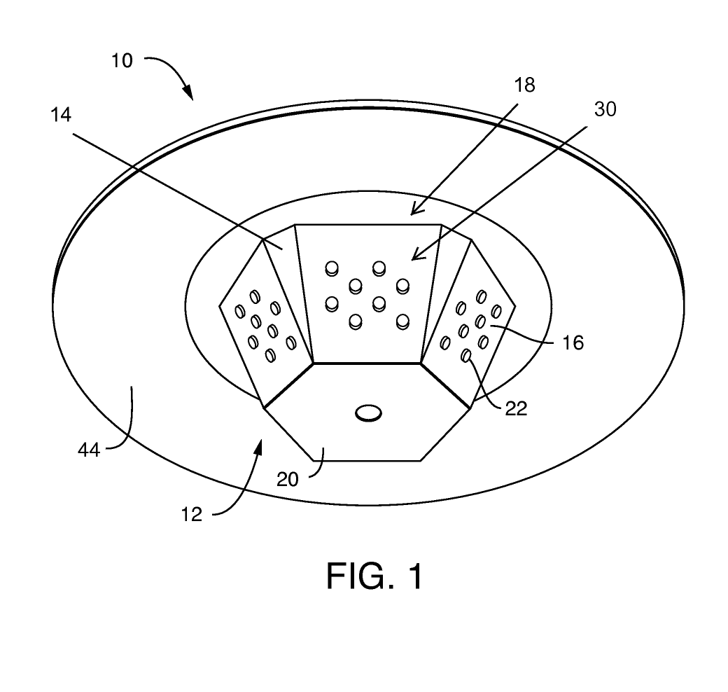

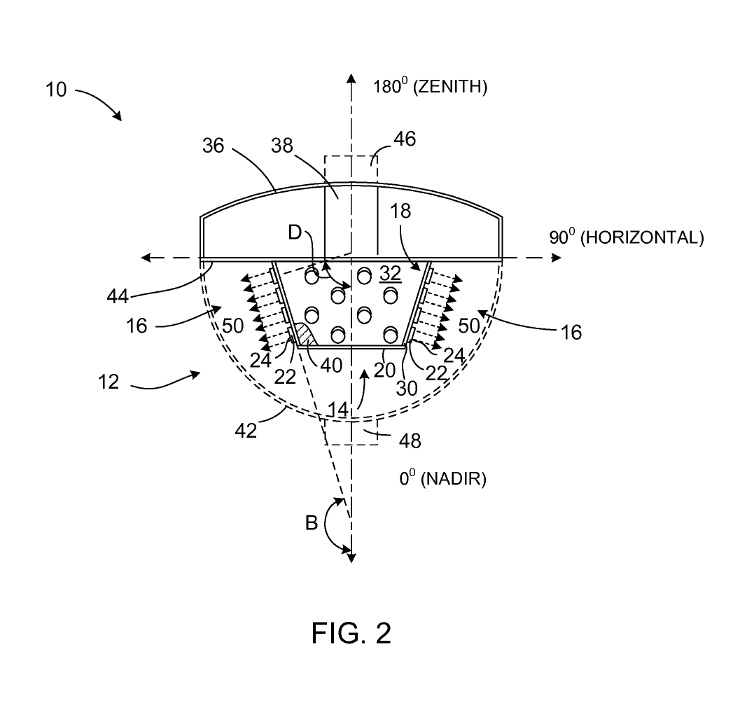

FIGS. 1 and 2 show a luminaire 10 including one or more solid state light sources. As used throughout, the term solid state light source(s) refers to one or more light emitting diodes (LEDs), organic light emitting diodes (OLEDs), polymer light emitting diodes (PLEDs), organic light emitting compounds (OLECs), and/or any other solid state light emitter, and/or combinations thereof in any arrangement. The luminaire 10 has an acorn shaped exterior, and in some embodiments, is particularly suited for use in lighting walkways, roadways, parking garages, and parking lots, to name a few applications. The luminaire 10 includes a light-emitting arrangement 12 which, as explained in further detail below, emits artificial light in a batwing distribution. As used herein, a batwing distribution is understood as a lighting distribution which reduces, and may particularly minimize or eliminate, downward light at large angles from the nadir (e.g. 70-90 degrees) to reduce direct glare, as well as reduces, and may particularly minimize or eliminate, downward light at small angles from the nadir (e.g. 0-20 degrees) to reduce reflected glare. The distribution produces the greatest intensity in the range of 20-70 degrees from nadir.

The light-emitting arrangement 12 comprises a light-emitting hub 14 having at least one light-emitting side 16 (shown in FIG. 1 as having a plurality of planar light-emitting sides 16) arranged to form a polygonal shape, which may particularly be, and in some embodiments is, a truncated pyramid. As shown in FIG. 1, the polygonal shape is that of a truncated hexagonal pyramid. However, in other embodiments, the light-emitting hub 14 may and does have the shape of a truncated pyramid which is a trigon (triangle), tetragon, pentagon, heptagon, octagon, enneagon, decagon, hendecagon, dodecagon, etc. It should be understood that the number of sides of the polygon should not be considered limiting, and that greater number of sides may afford a more uniform distribution of light around the light-emitting hub 14. At least one light engine 18 is located on each light-emitting side 16 of the light-emitting hub 14. The light engine 18 comprises at least one solid state light source 22 having an overlying lens that is electrically and mechanically coupled to a substrate 30, such as but not limited to a metal core printed circuit board (MCPCB). The substrate 30 for each light-emitting side 16 may be, and in some embodiments is, mounted to an underlying printed circuit board support structure 40, shown in FIG. 2 in partial cross-section beneath the substrate 30, which in some embodiments also has a polygonal shape. In some embodiments, a plurality of solid state light sources 22 are mounted on each substrate 30, such as in a geometric pattern of staggered rows, to emit light from every light-emitting side 16 of the light-emitting hub 14, except a bottom 20. In addition, the printed circuit board support structure 40, in some embodiments, includes a centrally disposed cavity for containing circuitry for the operation of the luminaire 10. This circuitry may, and in some embodiments does, comprise, for example, singly or in any combination, hardwired circuitry, programmable circuitry such as but not limited to computer processors comprising one or more individual instruction processing cores, state machine circuitry, and/or firmware that stores instructions executed by programmable circuitry. The printed circuit board support structure 40 may, and in some embodiments does, also provide a heat sink for the solid state light sources 22 and, as such is made of a metal, such as but not limited to, aluminum or steel, or combinations thereof, and/or any other heat-dissipating material.

As seen mostly clearly in the cross-section of FIG. 2, the luminaire 10, in some embodiments, include an upper enclosure 36, having a mounting structure 38 to which the light-emitting hub 14 is mounted, particularly the printed circuit board support structure 40. The upper enclosure 36 includes, in some embodiments, a reflector 44 that is arranged to direct light from the light-emitting hub 14 downwards as explained in greater detail below. The reflector 44, in some embodiments, is a specular reflector, and in other embodiments, is a diffusive reflector, and in some embodiments, is another type of reflector. In embodiments where the reflector 44 is a specular reflector, in order to provide specular reflection, the reflector 44 includes a layer of specular reflection material for very high reflectivity (e.g. 98%) such as, but not limited to, 3M Vikuiti film or Alanod MIRO-SILVER. In embodiments where the reflector 44 is a diffusive reflector, in order to provide a diffusive reflection, the reflector 44 includes, for example, white paint or a Furukawa reflective sheet, or combinations thereof.

Continuing with FIG. 2, the LED luminaire 10, in some embodiments, optionally includes a thin, light transmissive lower enclosure 42 that extends completely around and/or beneath the light-emitting hub 14 to protect the light-emitting hub 14 from the outside elements, such as rain and snow. The light transmissive lower enclosure 42, in some embodiments, is diffusive, and in some embodiments, is prismatic, and is made of glass or plastic such as polycarbonate (PC) or polymethylmethacrylate. The lower enclosure 42 may, in some embodiments, seal with the upper enclosure 36 to provide an ingress protection (“IP”) rating, such as IP Code 66. The luminaire 10 may, and in some embodiments does, also include one or more mounting brackets, particularly an upper bracket 46 that mounts to an overlying structure, such as but not limited to a ceiling or an overhead arm, and/or a lower bracket 48 that mounts to an underlying structure, such as but not limited to a lamp post.

As shown in FIG. 2, the solid state light sources 22 may have a planar light-emitting major surface 24 and include a lens, such as but not limited to a total internal reflection lens, which collimates light from the solid state light sources 22 such that direct light 50 emitted from the planar surface 24 is emitted substantially perpendicular (i.e. within a few degrees) to the planar surface 24. By utilizing solid state light sources 22 that include a total internal reflection lens, lighting interference between adjacent solid state light sources 22 may be best inhibited and packaging space between adjacent solid state light sources 22 may be minimized. However, it should be understood that embodiments are not limited to use of solid state light sources 22 with a total internal reflection lens. In some embodiments, the solid state light sources 22 have a full width at half maximum (FWHM) of less than 80 degrees. In some embodiments, the solid state light sources have a full width at half maximum (FWHM) in a range of 80 to 150 degrees.

The substrate 30 of each light-emitting side 16 are arranged, particularly angled relative to nadir, such that direct light 50 emitted normal (perpendicular) from the solid state light sources 22, which in some embodiments have a total internal reflection lens, is emitted from the light-emitting arrangement 12 at a direct light angle D in a range of 0 degrees to 90 degrees from nadir, and more particularly in a range of 20 degrees to 70 degrees from nadir. In such embodiments, the substrates 30 may be understood to be mounted to the printed circuit board support structure 40 with the outer surface 32 of each substrate 30 at a board angle B in a range of 90 degrees to 180 degrees from nadir, and more particularly in a range of 110 degrees to 160 degrees from nadir.

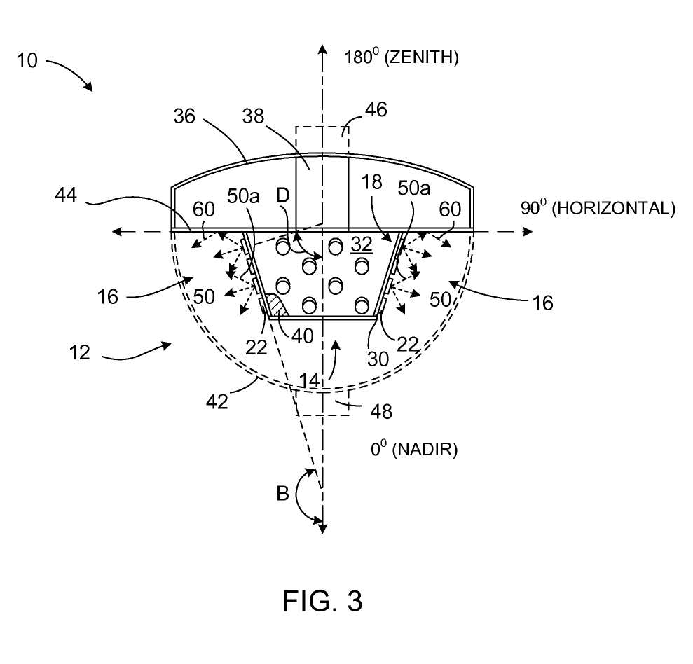

In other embodiments, such as the luminaire 10 shown in FIG. 3, the solid state light sources 22 have a much wider beam angle. Such may be the case when use of a total internal reflection lens is eliminated from the solid state light sources 22. In such embodiments, the solid state light sources 22 are packaged, for example, to provide an 80 degree beam angle (e.g., an Oslon 80 available from OSRAM Opto Semiconductors), 120 degree beam angle (e.g., an Oslon square available from OSRAM Opto Semiconductors), or a 150 degree beam angle (e.g., an Oslon 150 available from OSRAM Opto Semiconductors), among others.

In FIG. 3, an amount of direct light 50 from the light emitting hub 14 is reflected on the reflector 44 and the reflected light 60 is emitted from the light-emitting arrangement 12. Also, a certain amount of direct light 50 from the light emitting hub 14 may be directed upward (i.e. at an angle of greater than ninety degrees to nadir) to provide uplighting 50a. However, such reflected light 60 and upwardly directed direct light 50a, as well as potential interference between the light from the various solid state light sources 22 may be understood to decrease the efficiency of the batwing light distribution. Thus, it should be understood that the beam width of the batwing distribution may, and in some embodiments does, depend on the lens utilized for the solid state light sources 22. For example, the beam width of the batwing distribution may be narrower in the case of solid state light sources 22 that include a total internal reflection lens as compared to solid state light sources 22 that do not make use of a total internal reflection lens. Similarly, it should be understood that the peak angle of the batwing distribution may, and in some embodiments does, depend on the board angle B utilized for the solid state light sources 22. For example, the peak angle for the batwing distribution may decrease with a corresponding decrease in board angle B, and conversely increase with a corresponding increase in board angle B. Thus, the luminaire 10 provides the ability to finely tune a batwing light distribution, particularly with regards to beam width by merely changing more conventional optics of the solid state light sources (e.g. solid state light sources with total internal reflection lenses as opposed to batwing lenses) and peak angle by changing the board angle B, without the time and cost associated with the construction of solid state light sources 22 with re-designed batwing lenses. Moreover, the batwing light distribution may also be refined by changes in the reflectivity of the reflector 44 as well as light transmission through the lower enclosure 42. Furthermore, by eliminating use of solid state light sources with an individual batwing lens/beam, the cost of the luminaire 10 may be reduced, interference between lenses may be eliminated, and optical efficiency may be increased. In addition, with the construction of the luminaire 10 as provided, upward lighting may be provided in addition to downward lighting without an increase in the number of solid state light sources 22 utilized.

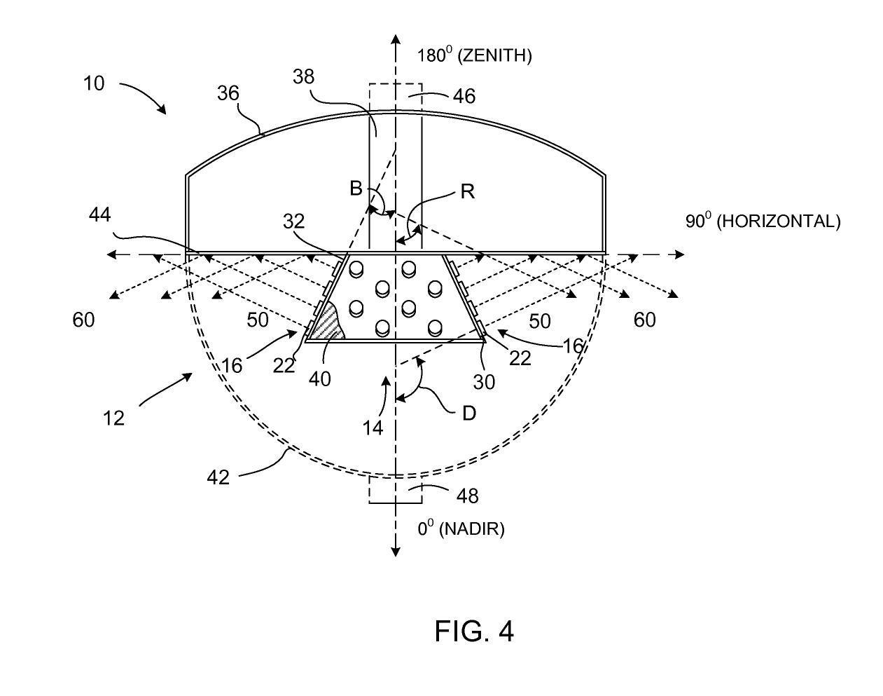

Referring now to FIG. 4, there is shown another embodiment of a luminaire 10. In contrast to the embodiment of FIGS. 1 and 2, which substantially use direct light 50 to create the batwing distribution, the luminaire 10 of FIG. 4 substantially uses reflected light 60 to create the batwing distribution. As shown, the substrates 30 are now arranged, particularly angled relative to nadir, such that direct light 50 emitted normal (perpendicular) from the solid state light sources 22 is emitted from the light-emitting arrangement 12 at a direct light angle D in a range of 90 degrees to 180 degrees from nadir, and more particularly in a range of 110 degrees to 160 degrees from nadir. In such embodiments, the substrates 30 may be understood to be mounted to the printed circuit board support structure 40 with the outer surface 32 of each substrate 30 at a board angle B in a range of 0 degrees to 90 degrees from nadir, and more particularly in a range of 20 to 70 degrees from nadir. The direct light 50 emitted normal (perpendicular) from the solid state light sources 22 may then be reflected (shown as specular) on the reflector 44 of the light-emitting arrangement 12. Given that the angle of reflectance of reflected light 60 on the reflector 44 will be the same as the angle of incidence of direct light 50 on reflector 44, the direct light 50 emitted normal (perpendicular) from the solid state light sources 22 and reflected on the reflector 44 is emitted at a reflected light angle R in a range of 0 degrees to 90 degrees from nadir, and more particularly in a range of 20 degrees to 70 degrees from nadir. In such case, the substrates 30 may be understood to be mounted to the printed circuit board support structure 40 with the outer surface 32 of each substrate 30 at a board angle B in a range of 0 degrees to 90 degrees from nadir, and more particularly in a range of 20 degrees to 70 degrees from nadir.

Similar to the luminaire 10 of FIG. 1, the reflector 44 may be, and in some embodiments is, either a specular reflector or a diffusive reflector; and in some embodiments, the solid state light sources 22 lack a total internal reflection lens. In contrast, however, the creation of the batwing distribution utilizing the reflector 44 provides greater flexibility in tuning the batwing distribution as the batwing distribution may be further controlled by the type of reflector utilized (specular or diffusive) in addition to the optics of the solid state light sources 22 and the angle B of the substrates 30. The luminaire 10 of FIG. 4 still provides the ability to finely tune a batwing light distribution, particularly with regards to beam width and peak angle, without the time and cost associated with the construction of the solid state light sources 22 with re-designed batwing lenses. Furthermore, by eliminating use of solid state light sources 22 with a batwing lens/beam, the cost of the luminaire 10 may be reduced, interference between lenses may be eliminated (or at least reduced), and optical efficiency may be increased. In addition, with the construction of luminaire 10 as provided, upward lighting may be provided in addition to downward lighting without an increase in the number of solid state light sources 22 utilized.

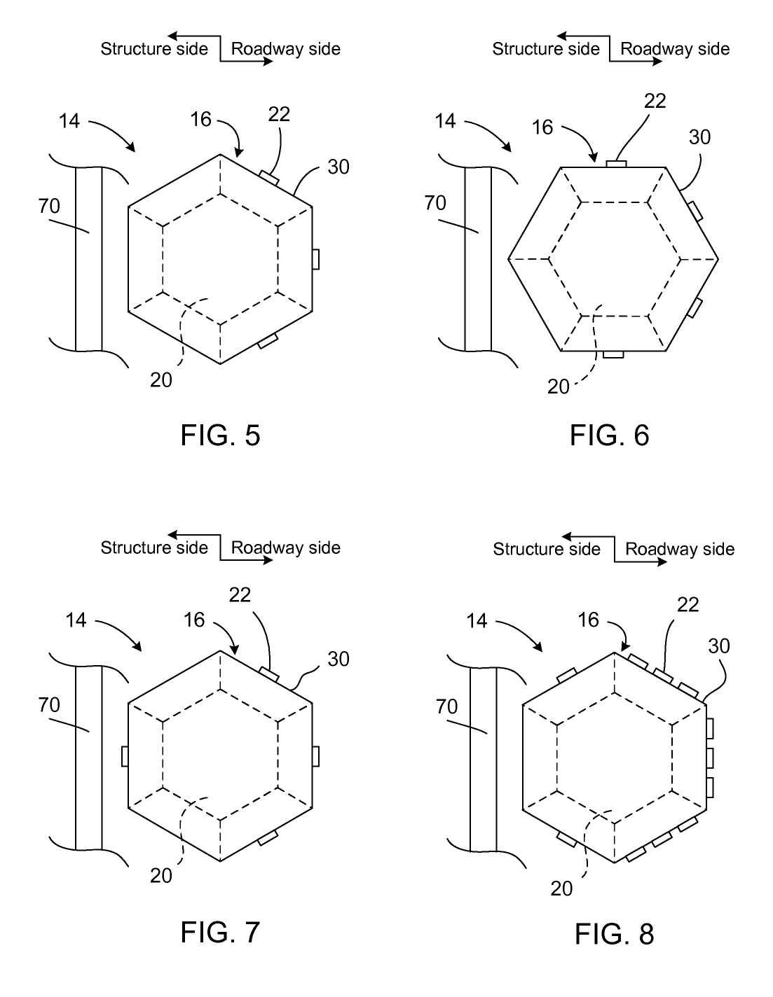

In FIGS. 1-4, each of the vertically oriented sides of the light-emitting hub 14 may be light-emitting sides 16 with symmetrically distributed solid state light sources to provide 360 degrees of lighting coverage. However, in some embodiments, it should be understood that not all of the vertically oriented sides of the light-emitting hub 14 are necessarily light-emitting sides 16. For example, as shown in FIGS. 5-8, when symmetry is not maintained, other types of radial asymmetric distributions of directed light with less than 360 degree of lighting coverage are achieved. Such may be desirable, for example, when more light from the luminaire 10 is desired on a roadway (street) side of the luminaire 10 as opposed to a fixed structure 70 to which the luminaire 10 may be adjacent, and particularly mounted thereto (e.g., a building, a house, etc.). All of FIGS. 5-8 show various arrangements in which the backlighting to the structure 70 may be decreased. Furthermore, as shown in FIG. 8, the number of solid state light sources 22 on the light-emitting sides 16 on the roadway side of the luminaire 10 may be greater than the number of solid state light sources 22 on the light-emitting sides 16 on the structure side of the luminaire 10.

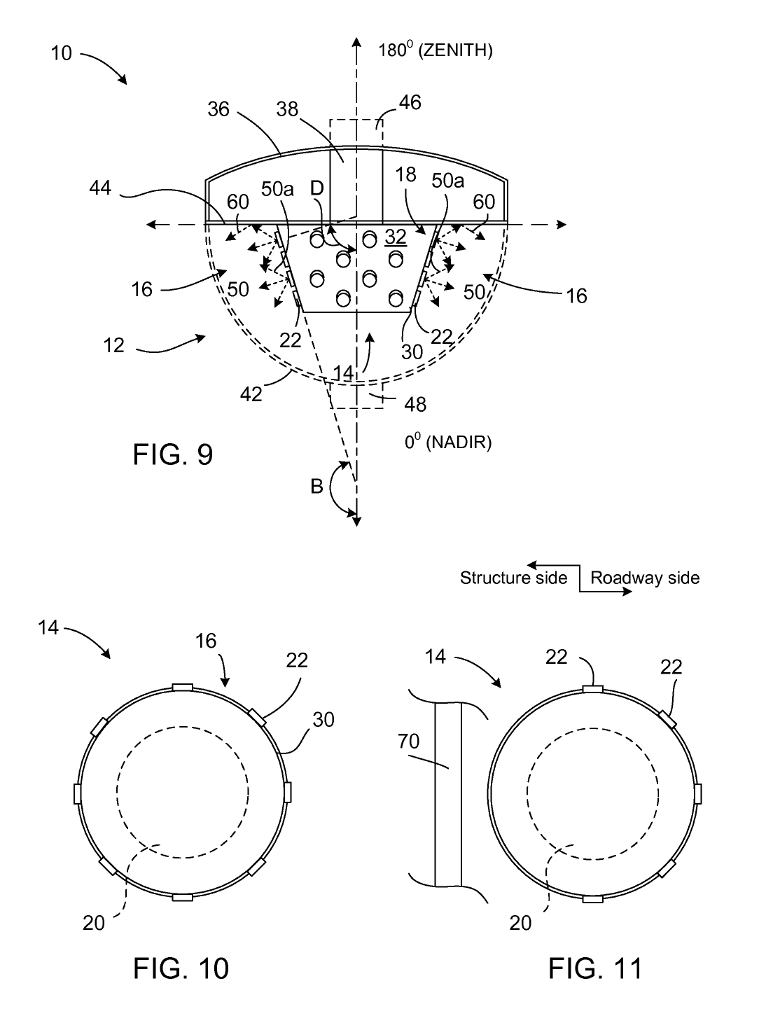

In other embodiments, such as shown in FIGS. 9-11, the light-emitting hub 14 has the shape of a truncated cone as opposed to the embodiments shown in FIGS. 1-8. In such embodiments, only one substrate 30 may be required, of a flexible or quasi-flexible nature, rather than a separate substrate 30 for each planar light-emitting side 16 of the light-emitting hub 14 the embodiments of FIGS. 1-8. Furthermore, in contrast to the embodiments of FIGS. 1-8, the light-emitting hub 14 of FIGS. 9-11 may be understood to have a continuous conical side as opposed to a plurality of discrete planar sides.

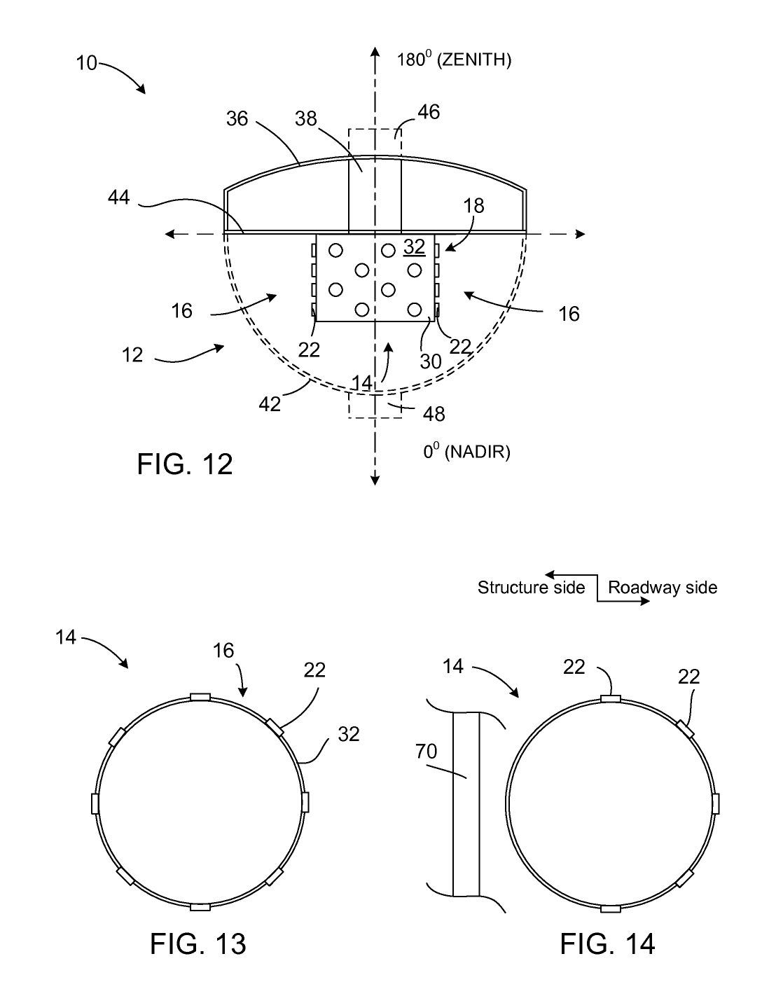

In other embodiments, such as shown in FIGS. 12-14, the light-emitting hub 14 has the shape of a cylinder. Similar to the embodiment shown in FIGS. 9-11, only one flexible and/or quasi-flexible substrate 30 may be required, rather than a separate substrate 30 for each planar light-emitting side 16 of the light-emitting hub 14. Furthermore, the light-emitting hub 14 of FIGS. 12-14 may be understood to have a continuous cylindrical side as opposed to a plurality of discrete planar sides.

It is understood that various omissions and substitutions of equivalents are contemplated as circumstances may suggest or render expedient. Also, it should be understood that the phraseology and terminology used herein is for the purpose of description and should not be regarded as limiting.

Unless otherwise stated, use of the word “substantially” may be construed to include a precise relationship, condition, arrangement, orientation, and/or other characteristic, and deviations thereof as understood by one of ordinary skill in the art, to the extent that such deviations do not materially affect the disclosed methods and systems.

Throughout the entirety of the present disclosure, use of the articles “a” and/or “an” and/or “the” to modify a noun may be understood to be used for convenience and to include one, or more than one, of the modified noun, unless otherwise specifically stated. The terms “comprising”, “including” and “having” are intended to be inclusive and mean that there may be additional elements other than the listed elements.

Elements, components, modules, and/or parts thereof that are described and/or otherwise portrayed through the figures to communicate with, be associated with, and/or be based on, something else, may be understood to so communicate, be associated with, and or be based on in a direct and/or indirect manner, unless otherwise stipulated herein.

Although the methods and systems have been described relative to a specific embodiment thereof, they are not so limited. Obviously many modifications and variations may become apparent in light of the above teachings. Many additional changes in the details, materials, and arrangement of parts, herein described and illustrated, may be made by those skilled in the art.

What is claimed is:

1. A luminaire, comprising:
a light-emitting arrangement comprising a hub having at least one light-emitting side; and
at least one light engine located on the at least one light-emitting side of the light-emitting hub, the at least one light engine comprising at least one solid state light source coupled to a substrate, the substrate arranged such that light from the at least one solid state light source is emitted at a light angle in a range of 0 degrees to 90 degrees from nadir to create a batwing distribution.

2. The luminaire of claim 1, wherein:
the hub of the light-emitting arrangement comprises a plurality of sides that form a truncated pyramid; and
the at least one light-emitting side of the hub is provided by one of the plurality of sides of the truncated pyramid.

3. The luminaire of claim 2, wherein the hub has a shape of a truncated cone.

4. The luminaire of claim 1, wherein the substrate is arranged such that direct light from the at least one solid state light source is emitted from the light-emitting arrangement at a direct light angle in a range of 0 degrees to 90 degrees from nadir.

5. The luminaire of claim 4, wherein the substrate is arranged at a board angle in a range of 90 degrees to 180 degrees from nadir.

6. The luminaire of claim 1, wherein the light-emitting arrangement further comprises a reflector, and wherein the substrate is arranged such that direct light from the at least one solid state light source is reflected by the reflector and the reflected light is emitted from the light-emitting arrangement at a reflected light angle in a range of 0 degrees to 90 degrees from nadir.

7. The luminaire of claim 6, wherein the substrate is arranged at a board angle in a range of 0 degrees to 90 degrees from nadir.

8. The luminaire of claim 7, wherein the substrate is arranged such that direct light from the at least one solid state light source is emitted from the light-emitting arrangement at a direct light angle in a range of 90 degrees to 180 degrees from nadir.

9. The luminaire of claim 1, wherein the at least one solid state light source has a planar light-emitting surface and includes a total internal reflection lens that collimates light from the at least one solid state light source such that light emitted from the planar surface is emitted substantially perpendicular to the planar surface.

10. The luminaire of claim 1, wherein the at least one solid state light source has a full width at half maximum of less than 80 degrees.

11. The luminaire of claim 1, wherein the at least one solid state light source has a full width at half maximum in a range of 80 to 150 degrees.

12. The luminaire of claim 1, wherein the substrate is further arranged such that upwardly directed direct light from the at least one solid state light source is emitted from the light-emitting arrangement.

13. The luminaire of claim 1, wherein the at least one light engine comprises a plurality of solid state light sources coupled to the substrate and arranged in a geometric pattern.

14. The luminaire of claim 1, wherein the light-emitting arrangement further comprises an enclosure that overlies the hub.
